(19) United States
(12) Patent Application Publication
(10) Pub. No.: US 2004/0232627 A1
(43) Pub. Date: Nov. 25, 2004

(54) Abrasion and oil resistant pipe gasket and coating

(76) Inventor: Bradford G. Corbett JR., Fort Worth, TX (US)

Correspondence Address: WHITAKER, CHALK, SWINDLE & SAWYER, LLP, 3500 CITY CENTER TOWER II, 301 COMMERCE STREET, FORT WORTH, TX, 76102-4186, US

(21) Appl. No.: 10/776,842

(22) Filed: Feb. 11, 2004

Related U.S. Application Data
(60) Provisional application No. 60/446,614, filed on Feb. 11, 2003.

(51) Int. Cl. H02G 15/04

(52) U.S. Cl. 277/602

(57) ABSTRACT

An improved pipe belling process is shown which a gasket is installed on the outer working surface of a forming mandrel at one circumferential location. The heated socket end of a thermoplastic pipe is forced over the mandrel exterior and over the gasket causing the heated socket end of the pipe to flow over the gasket and form a retention groove for retaining the gasket before again contacting the working surface of the mandrel. The heated end of the pipe is cooled and retracted from the working surface of the mandrel. The gasket has a special anti-corrosion and anti-friction coating applied to portions of the exterior thereof.

### CROSS-REFERENCE TO RELATED APPLICATIONS

The present application claims priority from Provisional Application Serial No. 60/446,614, filed Feb. 11, 2003, entitled “Abrasion and Oil Resistant Pipe Gasket and Coating”, by the same inventor.

### BACKGROUND OF THE INVENTION

1. Field of the Invention

The present invention relates generally to sealing systems for fluid conveying pipes and, more specifically, to an improved belling process for installing a gasket in a socket end of a thermoplastic pipe.

2. Description of the Prior Art

A variety of piping systems are known for the conveyance of fluids which employ elastomeric type sealing rings or gaskets. The pipes used in such systems may be formed of PVC, polyolefins such as PE and PP, ductile iron, concrete, clay, fiberglass, steel, cast iron, fiberglass/cement reinforced pipes and such metals as aluminum and copper. Pipes formed from thermoplastic materials including polyethylene and PVC are used in a variety of industries but are particularly useful in municipal water and sewage systems. In forming a joint between thermoplastic sections of pipe, the spigot or male pipe end is inserted within the female or socket pipe end. An annular, elastomeric ring or gasket is typically seated within a groove formed in the socket end of the thermoplastic pipe. As the spigot is inserted within the socket, the gasket provides the major seal capacity for the joint. It is critical, during the installation process, that the gasket not be able to twist or flip since a displaced or dislocated gasket will adversely affect the ultimate sealing capacity of the joint.

Despite advances in the art of sealing rings for fluid conveying piping, certain problems continue to occur both in the manufacture of the joint and integral gasket and in certain field applications. In the manufacturing plant, frictional resistance between the gasket and mandrel or pipe could hamper the forming operation. In some field operations, particularly involving larger diameter pipe, the insertion force needed to install the male spigot end within the mating socket end could, on some occasions, cause the gasket to be distorted or displaced.

One attempted solution, both in the manufacturing plant and in the field, was to utilize a liquid lubricant to reduce frictional forces. The lubricant could be applied during formation of the pipe joint and at the point of assembly of the pipe joint in the field, as by brushing, spraying or dipping the gasket in a suitable liquid or viscous lubricant compound. This approach was messy and inconsistent and often proved to be unsatisfactory. The lubricating effect was not permanent or even semi-permanent.

Accordingly, it is an object of the present invention to provide an improved pipe belling process of the type described which is more efficient and which produces more consistent results utilizing a fixed external coating rather than using a liquid lubricant.

It is also an object of the present invention to provide a pipe gasket with a novel external permanent coating which facilities the manufacturing operation and which also provides a lower insertion force for the male, spigot end when entering the female, spigot end to facilitate assembly of the pipe joint in the field.

Another object of the invention is to provide a permanent, external coating for a sealing gasket of the type described, which coating provides improved abrasion resistance, greater oil resistance than nitrile rubber at a fraction of the cost as well as the option of color coding gaskets by type or application.

### SUMMARY OF THE INVENTION

A method is shown for installing a gasket in a socket end of a thermoplastic pipe which is used to form a pipe coupling. A mandrel is provided with an inner end and an outer end and having a generally cylindrical outer working surface. A gasket is installed at a first circumferential position on the outer working surface. The gasket has at least selected surfaces coated with the coating of the invention. A retention member is provided at a second circumferential location on the mandrel nearer the inner end of the mandrel with the retention member abutting the gasket in a normally extended position. A socket end of a thermoplastic pipe is then heated and forced over the working surface of the mandrel and over the gasket, whereby the heated socket end of the thermoplastic pipe flows over the gasket to form a retention groove for retaining the gasket and again contacts the working surface of the mandrel. The heated socket end of the thermoplastic pipe is then cooled and retracted from the mandrel leaving the gasket within the retention groove of the pipe end.

One preferred class of materials is sold commercially by Lord Chemical Products of Erie, Pa., as the Lord Elastomeric Coating. These elastomeric coatings have excellent adhesion properties and environmental resistance, and are capable of strains of several hundred percent. These coatings have been applied on elastomeric products to improve appearance, resistance to fluids and resistance to ozone. The coatings can enable a less expensive material to be used in products with characteristics equivalent to more expensive materials. The coatings can be colored as well.

One preferred coating is manufactured by Lord Chemical Products of Erie, Pa., as the CHEMGLAZE® polyurethane coating. This is a high performance coating that will withstand severe temperature, chemical attack and abrasion. The anti-friction and chemical resistant coating is conveniently applied by spraying on at least selected external surfaces of the gasket followed by a drying period as recommended by the manufacturer.

Another particularly preferred coating is the Lord Elastomeric Coating manufactured by Lord Mechanical Products Division and marketed under the tradename ENDURALAST™ Tire Coating.

In the preferred embodiment, the gasket is an elastomeric, ring shaped member having a circumferential contact area and an exterior surface, coating of the invention being applied to at least selected portions of the circumferential contact area.

Additional objects, features and advantages will be apparent in the written description which follows.

### BRIEF DESCRIPTION OF THE DRAWINGS

FIG. 1 is a partial, perspective view, partly broken away showing a pipe joint manufactured according to the method of the invention, the male spigot pipe end being inserted within a female socket end to form the pipe joint;

FIG. 2 is a side, cross-sectional view of a gasket used in the method of the invention, the gasket having the external coating of the invention applied to a contact surface thereof;

FIGS. 3-6 are simplified, schematic illustrations of the prior art RIEBER™ process for installing a compression, seal gasket within a groove formed within the female socket end of a thermoplastic pipe;

### DETAILED DESCRIPTION OF THE INVENTION

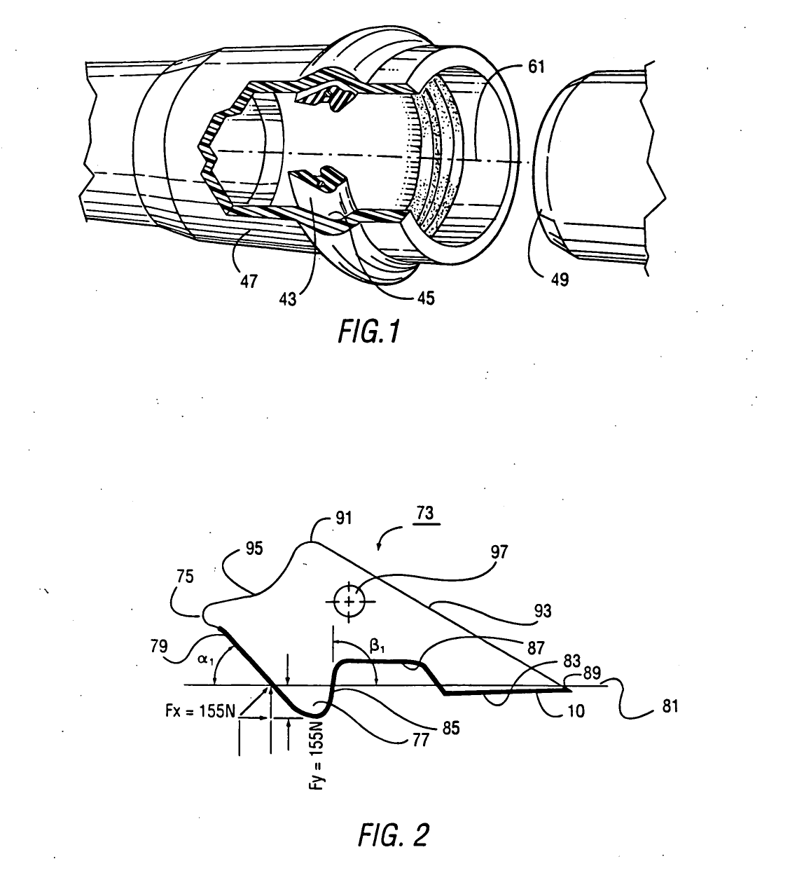

FIG. 1 shows a sealing gasket of the invention, designated generally as 43 which is installed within a groove 45 provided within a socket end 47 of a thermoplastic pipe. The gasket 43 has the improved non-stick anti-friction coating so that insertion of the male, spigot pipe section 49 within the female, socket section 47 can be achieved with a minimum insertion force while maintaining the desired compression seal for the joint so made up.

Turning to FIG. 2, there is shown a pipe sealing gasket of the invention designated generally as 73. The gasket 73, includes a nose region 75 which is joined to a lower compression region 77 by a leading curved surface region 79 which defines an angle α₁, with respect to the horizontal axis 81 drawn parallel to a central axis 61 of the pipe. The lower compression region 77 is joined to a secondary seal surface 83 by a trailing curved surface region 85 and an intermediate circumferential groove region 87. The trailing curved surface region 85 defines a second angle P with respect to the horizontal axis 81 drawn parallel to the central axis 61 of the pipe.

The secondary seal surface 83 is a planar circumferential region which terminates in an inside corner 89 of the gasket 73. The inside corner is connected to an outer arcuate region 91 of the gasket 73 by a uniformly sloping exterior gasket surface 93. The outer arcuate region 91 is connected to the nose region 75 of the gasket by a concave curved region 95. The gasket 93 may also be provided with a reinforcing element such as the metal ring 97.

The gasket 73 is thus an elastomeric, ring shaped member having a circumferential contact area, e.g., the leading curved surface region 79, the lower compression region 77 and the secondary seal surface 83. The gasket also has an exterior surface which includes the regions 93 and 95 which generally contact the interior of the thermoplastic pipe during the forming operation. In the method of the invention, selected surfaces of the gasket are coated with the external coating of the invention. Generally, at least the leading curved surface region 79 is coated with special external coating. Preferably, the regions 79, 77 and 83 all have the coating applied thereto.

One preferred class of materials, as described in the Summary of the Invention, is sold commercially by Lord Chemical Products of Erie, Pa., as the Lord Elastomeric Coating. These elastomeric coatings have excellent adhesion properties and environmental resistance, and are capable of strains of several hundred percent. These coatings have been applied on elastomeric products to improve appearance, resistance to fluids and resistance to ozone. The coatings can enable a less expensive material to be used in products with characteristics equivalent to more expensive materials. The coatings can be colored as well. These coatings can typically be applied by spraying on at least selected external surfaces of the gasket followed by a drying period as recommended by the manufacturer.

The coating which is applied to the selected surfaces of the gasket is a synthetic polymeric coating. One preferred coating is a synthetic polymer, preferably thermoplastic, most preferably a polyurethane high performance coating that will withstand severe temperature, chemical attack and abrasion. A particularly preferred coating for certain gasket applications is manufactured by Lord Chemical Products of Erie, Pa., as the CHEMGLAZE® polyurethane coating. This is a high performance coating that will withstand severe temperature, chemical attack and abrasion. The anti-friction and chemical resistant coating can be applied by any technique generally used in the industry and is conveniently applied by spraying on at least selected external surfaces of the gasket followed by a drying period as recommended by the manufacturer. The spraying technique can be by conventional air atomized spray coating using a spray gun.

CHEMGLAZE® is an elastomeric polyurethane coating which exhibits inherent flexibility, corrosion resistance and energy absorbing properties. Manufacturers Technical Data for the product is as follows:

| Mix ratio A/B by volume | 3/1 supplied in premeasured kits |
|---|---|
| Percent solids (by weight) | 56 |
| Volatile organic compounds | 3.5 lb/gal |
| Tack free time | 30 min. |
| Physical Properties of Cured Coatings: | |
| Tensile strength ASTM D 412 | 5000 psi |
| Method A, Die C | |
| Percent Elongation | |
| ASTM D 412 Method A, Die C | 500 percent |
| Taber Abraser | |
| CS17 1000 g/1000 cycles | No loss |
| Durometer Shore A | 110 |

Mixing and recommended spray application techniques are given in the manufacturer's REMR Material Data Sheet, CM-SE-1.9.

Another particularly preferred coating is the Lord Elastomeric Coating manufactured by Lord Mechanical Products Division and marketed under the tradename ENDURALAST™ Tire Coating. This product has excellent adhesion properties and environmental resistance and is capable of strains of several hundred percent. In one application technique, the external gasket surface is first cleaned to remove contaminants from the surface. For this purpose, the gaskets can be wiped with a pre-coating treatment such as the Lord Pre-Bond Cleaner 02CX. The coating is then applied to the gasket surface by brushing or spraying on.

The coatings used in the method of the invention can also have a color additive, such as a suitable pigment, dispersed therein which impart a distinctive color to the coated region of the gasket. Color markings of this type can be used for product identification purposes, e.g., for use as a water pipe joint, a sewer pipe joint, etc.

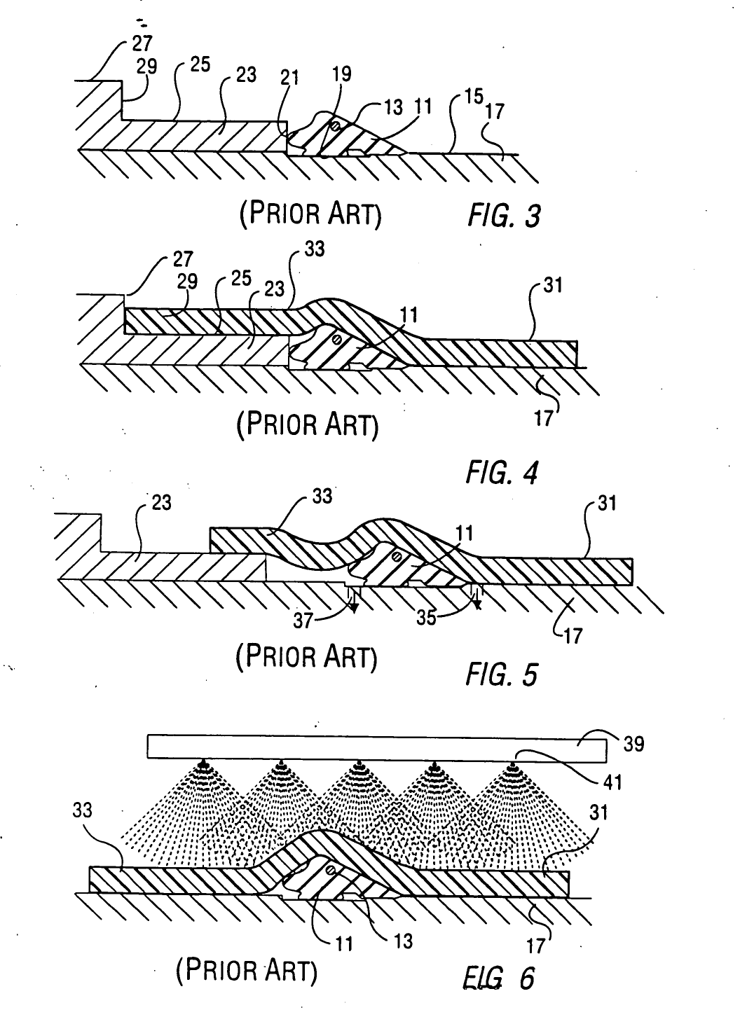

The advantages of the method of the invention can best be understood with reference to a simplified discussion of the prior art Rieber process. Turning first to FIGS. 3-6, the prior art process is illustrated. FIG. 3 shows a section of a conventional elastomeric sealing gasket 11 having a steel reinforcing ring 13 in place on the generally cylindrical outer working surface 15 of the mandrel 17 used in the belling process. The elastomeric gasket 11 can be formed of, for example, natural or synthetic rubber or blends thereof including SBR and is a ring shaped, circumferential member having an inner compression surface 19 and an exposed nose portion 21 which, as shown in FIG. 3, abuts a forming collar 23. The forming collar 23 has a first generally cylindrical extent 25 which is joined to a second cylindrical extent 27 by a step region 29, whereby the second extent 27 is of greater external diameter than the first cylindrical extent 25, shown in FIG. 3.

In the first step of the prior art process, the steel reinforced elastomeric ring 11 is thus placed onto the working surface of the mandrel 17 and pushed to a position against the back-up or forming collar 23. In this position, the gasket is firmly anchored to the mandrel surface with the rubber between the mandrel and the steel-ring of the gasket being compressed by approximately 20%.

In the second step of the prior art process, the socket end 33 of the thermoplastic pipe 31 is heated and pushed over the steel mandrel 17, gasket 11 and back-up collar 23. The socket end 33 is expanded due to the thermoplastic nature of the pipe. A number of thermoplastic materials, such as polyethylene, polypropylene and polyvinylchloride (PVC) are known in the prior art having the required expansion characteristics, depending upon the end application of the pipe joint. The socket end 33 flows over the first cylindrical extent 25 of the back-up collar 23 and abuts the step region 29 in the second step of the process.

In the next step of the prior art process (FIG. 5) the mandrel and pipe move away from the back-up collar 23 and the pipe socket end 33 retracts around the mandrel and gasket 11 due to the elastic forces of the thermoplastic material. Typically, vacuum was also applied through ports 35, 37 which connected the mandrel working surface with a vacuum source (not shown).

In the final step of the prior art process, the pipe socket end 33 is cooled by means of a water spray bar 39 and spray nozzles 41. As the cooling takes place, the pipe socket end 33 shrinks around the gasket 11, thus compressing the rubber body of the gasket between the steel reinforcing ring 13 and the socket-groove to establish a firm seal.

The corrosion resistant, anti-friction coating which is applied to the selected gasket surfaces facilitates the above described manufacturing processes as well as subsequent make up of the pipe joint in the field. The coating reduces scrap rate in the manufacturing plant since gaskets can be more easily and accurately installed on the forming mandrel with reduced frictional forces. It is not necessary to modify the existing manufacturing dies used in the belling process.

The sprayed on coating reduces the mess associated with liquid lubricants which were often applied to the inside, outside or both surfaces of the gasket. Certain of the water based lubricants used in the past required relubricating during the process which was messy and inefficient. Another advantage is that the installer is not required to select the proper lubricant since the coating is already in place prior to the manufacturing operation. The coating improves the shelf life of the gasket. Oxidation resistance is improved so that SBR type materials are offered added protection when exposed to direct sunlight. The coating of the invention provides a gasket which is more oil resistant than nitrile rubber but at a fraction of the cost. In field applications, insertion forces are reduced without altering the efficiency of the compression seal. Colored coatings can be used to mark the product type, thereby making the particular gasket type easy to recognize. The coating assists in preventing infiltration of contaminants in the case of water pipes while assisting in preventing exfiltration in the case of sewage pipes.

While the invention has been shown in only one of its forms, it is not thus limited but is susceptible to various changes and modifications without departing from the spirit thereof.

What is claimed is:

1. A method of installing a gasket in a socket end of a thermoplastic pipe which is used to form a pipe coupling, the method comprising the steps of:
providing a mandrel with an inner end and an outer end and having a generally cylindrical outer working surface;
installing a gasket at a first circumferential position on the outer working surface, the gasket having at least selected surfaces coated with an external polymeric anti-corrosion and anti-friction coating;
providing a retention member at a second circumferential location on the mandrel nearer the inner end of the mandrel, the retention member abutting the gasket in a normally extended position but being retractable to a retracted position in a subsequent manufacturing step;
heating a socket end of the thermoplastic pipe;
forcing the heated socket end of the thermoplastic pipe over the working surface of the mandrel and over the gasket with the retention member being in the extended position, whereby the heated socket end of the thermoplastic pipe flows over the gasket to form a retention groove for retaining the gasket and again contacts the working surface of the mandrel;
cooling the heated socket end of the thermoplastic pipe;
retracting the cooled socket end of the thermoplastic pipe and the retained gasket from the working surface of the mandrel.

2. The method of claim 1, wherein the coating when cured has the following published physical properties:

| Tensile strength ASTM D 412 | 5000 psi |
|---|---|
| Method A, Die C | |
| Percent Elongation | |
| ASTM D 412 Method A, Die C | 500 percent |
| Taber Abraser | |
| CS17 1000 g/1000 cycles | No loss |
| Durometer Shore A | 110 |

3. The method of claim 1, wherein the external coating is a Lord Elastomeric Coating sold under the tradename CHEMGLAZE™.

4. The method of claim 1, wherein the external coating is a Lord Elastomeric Coating sold under the tradename ENDURALAST™.

5. The method of claim 1, wherein the external coating is sprayed on.

6. The method of claim 1, wherein the gasket is an elastomeric, ring shaped member having a circumferential contact area and an exterior surface, and wherein the coating is applied to at least selected portions of the circumferential contact area.

7. An improved sealing gasket for sealing fluid conveying piping systems, the gasket comprising:
an elastomeric, ring shaped member having a circumferential contact area and an exterior surface, and wherein an external polymeric coating is applied to at least selected portions of the circumferential contact area.

8. The gasket of claim 7, wherein the coating when cured has the following published physical properties:

| Tensile strength ASTM D 412 | 5000 psi |
|---|---|
| Method A, Die C | |
| Percent Elongation | |
| ASTM D 412 Method A, Die C | 500 percent |
| Taber Abraser | |
| CS17 1000 g/1000 cycles | No loss |
| Durometer Shore A | 110 |

9. The method of claim 7, wherein the external coating is a Lord Elastomeric Coating sold under the tradename CHEMGLAZE™.

10. The method of claim 7, wherein the external coating is a Lord Elastomeric Coating sold under the tradename ENDURALAST™.
